(19) United States
(12) Patent Application Publication
(10) Pub. No.: US 2022/0343040 A1
(43) Pub. Date: Oct. 27, 2022

(54) STRESS INTENSITY FACTOR EVALUATION SYSTEM AND METHOD USING VIRTUAL GRID

(71) Applicant: UIF (University Industry Foundation), Yonsei University, Seoul (KR)

(72) Inventors: Kyoungsoo PARK, Seoul (KR); Habeun Choi, Seoul (KR)

(21) Appl. No.: 17/674,055

(22) Filed: Feb. 17, 2022

(30) Foreign Application Priority Data
Apr. 21, 2021 (KR) 10-2021-0051761

(51) Int. Cl. G06F 30/23

(52) U.S. Cl. CPC G06F 30/23; G06F 2111/10

(57) ABSTRACT

Disclosed herein is a stress intensity factor evaluation system using a virtual grid in which a control server having a computational function is executed via a computer. The control server includes: a virtual grid generation unit configured to generate a virtual grid; a nodal displacement calculation unit configured to calculate the nodal displacement of the generated virtual grid; a stress field calculation unit configured to calculate the stress field of the virtual grid; and a stress intensity factor evaluation unit configured to calculate a J-integral value and a stress intensity factor.

### BACKGROUND

### 1. Technical Field

The present invention relates to a stress intensity factor evaluation system and method. More particularly, the present invention relates to a stress intensity factor evaluation system and method using a virtual grid.

### 2. Description of the Related Art

The evaluation of the stress intensity factor (SIF) is significant in determining when and where a crack propagates in structures and materials. The stress intensity factor is a term based on fracture mechanics, and is a parameter representing a stress state around a crack tip.

For the accurate evaluation of the stress intensity factor, it is necessary to generate a high-quality finite element mesh near a crack tip and perform numerical analysis.

In the standard finite element analysis, the accuracy of a numerical solution considerably depends on the quality of finite elements.

In particular, since a stress field is the first derivative of a numerical solution, it is more affected by the quality of a finite element mesh. However, to generate a high-quality mesh along a three-dimensional crack front, an extensive amount of time and effort may be required.

If a free mesh is utilized instead of a high-quality mesh such as a crack-tip mesh to evaluate the stress intensity factor, an inaccurate stress intensity factor could be expected. However, in order to achieve the accuracy of the stress intensity factor, it requires a lot of time and effort to maintain mesh quality beyond a certain level for the arbitrary shapes of cracks and domain.

Domestic and international organizations have been conducted basic research for the prediction of crack propagation using numerical methods such as the extended Finite Element Method (XFEM). When XFEM is utilized to the crack propagation problem, two-dimensional problems can be solved relatively easier but it shows limitations to calculate the stress intensity factors of three-dimensional nonplanar crack.

Therefore, in order to evaluate the stress intensity factor using the XFEM approach of commercial software, it is necessary to develop a new element library or to modify the existing analysis program overall.

[Related Art Document]

Patent document: Korean Patent No. 10-1447833 (published on Sep. 29, 2014)

### SUMMARY

A stress intensity factor evaluation system and method using a virtual grid according to the present invention have the following objects:

First, since it is difficult to generate a high-quality mesh in order to represent a complex crack shape and also a relatively low-quality mesh is generated during a process of crack propagation analysis, it is necessary to modify the mesh during the process of crack propagation analysis. Accordingly, a stress recovery technique is proposed for the evaluation of an accurate stress field in a low-quality mesh.

Second, although the generation of a high-quality finite element mesh is essential to the accurate evaluation of the stress intensity factor, a user of an analysis program needs to spend a lot of time and effort to generate a high-quality mesh. Therefore, a novel method is proposed to evaluate the accurate stress intensity factor using a low-quality mesh while reducing the time for mesh generation.

Third, the present invention intends to calculate an accurate stress intensity factor value based on a stress field obtained using a virtual grid in a finite element domain including an arbitrary crack tip.

The objects of the present invention are not limited to those described above, and other objects that are not described above will be clearly understood by those of ordinary skill in the art from the following description.

According to an aspect of the present invention, there is provided a stress intensity factor evaluation system using a virtual grid in which a control server having a computational function is executed via a computer, the control server including: a virtual grid generation unit configured to generate a virtual grid; a nodal displacement calculation unit configured to calculate the nodal displacement of the generated virtual grid; a stress field calculation unit configured to calculate the stress field of the virtual grid; and a stress intensity factor evaluation unit configured to calculate a J-integral value and a stress intensity factor.

The virtual grid generation unit may be further configured to generate the virtual grid using two-dimensional four-node elements or three-dimensional eight-node elements in a target region for stress recovery.

The center of the virtual grid may be identical to the location of a crack tip, and the shape and size of the virtual grid may be determined according to the shape and size of finite elements.

The nodal displacement calculation unit may include a displacement field calculation unit configured to calculate the displacement field of the virtual grid through interpolation using shape functions used for finite element analysis and the nodal location of the virtual grid.

When the location of the virtual grid node is located inside a finite element, the nodal displacement of the virtual grid may be calculated by Equation 2 below:

uₚ=ξ₁u₁+ξ₂u₂+ξ₃u₃ (2)

where uₚ denotes the nodal displacement of the virtual grid, u₁, u₂, and u₃ denote the nodal displacements of the finite element nodes, and ξ₁, ξ₂, and ξ₃ denote the shape functions of the finite element.

In a triangular finite element, the shape functions may be calculated by Equation 3 below:

$${ξ}_{1} = \frac{1}{2 A} [ ( {x}_{2} {y}_{3} - {x}_{3} {y}_{2} ) + ( {y}_{2} - {y}_{3} ) x + ( {x}_{2} - {x}_{3} ) y ] \qquad ( 3 )$$

$${ξ}_{2} = \frac{1}{2 A} [ ( {x}_{3} {y}_{1} - {x}_{1} {y}_{3} ) + ( {y}_{3} - {y}_{1} ) x + ( {x}_{3} - {x}_{1} ) y ]$$

$${ξ}_{3} = \frac{1}{2 A} [ ( {x}_{1} {y}_{2} - {x}_{2} {y}_{1} ) + ( {y}_{1} - {y}_{2} ) x + ( {x}_{1} - {x}_{2} ) y ]$$

where x₁, x₂, and x₃ and y₁, y₂, and y₃ are the coordinates of a triangular element, A is the area of the triangular element, and x and y are locations inside the triangle for which shape function values are to be calculated.

The nodal displacement calculation unit may further include a displacement field acquisition unit configured to calculate the nodal displacement of the virtual grid through the least squares method based on the coordinate and displacement values of a standard finite element and the location of the virtual grid node.

An equation for the least squares method for the displacement calculation of virtual grid node is defined as Equation 4 below:

rₓ=Pq^{x}−b^{x}, r_{y}=Pq^{y}−b^{y} (4)

where P is shape functions based on the coordinates of the finite element, b is the nodal displacement of the finite element, and the nodal displacement of the virtual grid is calculated by calculating constants q^{x} and q^{y}, minimizing r, through the least squares method and then multiplying P and q.

A variable m constituting the shape function matrix P may be calculated by Equation 5 below:

$$m = [ \begin{matrix}1 & \frac{x - {x}_{w}}{{h}_{w}} & \frac{y - {y}_{w}}{{h}_{w}}\end{matrix} ] \qquad ( 5 )$$

where x and y denote locations inside the triangle for which shape function values are to be calculated, x_{w} and y_{w} denote coordinates of the triangle nodes, and h_{w} denotes the size of the triangle.

The stress field calculation unit may calculate stress values at Gauss points of the virtual grid by using the shape functions and the nodal displacements of the virtual grid.

The stress field calculation unit may be further configured to calculate the stress field by taking a first derivative of the displacement field on the virtual grid acquired by the displacement field acquisition unit.

The stress intensity factor evaluation unit may be further configured to calculate the value of the stress intensity factor using results, calculated by the nodal displacement calculation unit and the stress field calculation unit, and a domain integral method.

A domain for the domain integral may be the generated virtual grid and may be integrated according to Equation 8 below:

$$J = {\int }_{A} ( {σ}_{ij} \frac{\partial {u}_{j}}{\partial {x}_{k}} - W {δ}_{k i} ) \frac{\partial {q}_{k}}{\partial {x}_{i}} d A - {\int }_{{C}^{+} + {C}^{-}} {t}_{i} \frac{\partial {u}_{i}}{\partial {x}_{k}} {q}_{k} d C \qquad ( 8 )$$

where σᵢⱼ is stress, tᵢ is traction acting on a crack surface, uᵢ is a displacement, W is strain energy, δₖᵢ is the Kronecker delta, and qₖ is an arbitrary continuous function, which has a value of 1 at a crack tip and a value of 0 at a boundary of an integral domain.

The value of the stress intensity factor may be acquired according to the plane stress or strain conditions of a finite element analysis defined by Equation 10 below:

K_{I}=½\sqrt{E*}(\sqrt{J₁−J₂}+\sqrt{J₁+J₂})

K_{II}=½\sqrt{E*}(\sqrt{J₁−J₂}−\sqrt{J₁+J₂}) (10)

where K_{I} and K_{II} denote first- and second-mode stress intensity factors, respectively, and J₁ and J₂ denote first- and second-mode J-integral values, respectively.

E* may be calculated by Equation 11 below:

E*=E (plane stress)

E*=E/(1−v²) (plane strain) (11)

where E and v are elastic modulus and Poisson's ratio, respectively.

According to another aspect of the present invention, there is provided a stress intensity factor evaluation method using a virtual grid that is performed by a control server having a computational function via a computer, the stress intensity factor evaluation method including: generating, by the virtual grid generation unit of the control server, a virtual grid; calculating, by a nodal displacement calculation unit, the nodal displacement of the generated virtual grid; calculating, by a stress field calculation unit, the stress field of the virtual grid; and calculating, by a stress intensity factor evaluation unit, a J-integral value and a stress intensity factor.

According to still another aspect of the present invention, there is provided a computer program stored in a computer-readable storage medium in order to execute the stress intensity factor evaluation method of claim 16 via a computer in combination with hardware.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a block diagram of a stress intensity factor evaluation system using a virtual grid (a virtual mesh) according to the present invention;

FIG. 2 is a flowchart of a stress intensity factor evaluation method using a virtual grid according to the present invention;

FIG. 3 shows the types of finite element meshes, wherein FIG. 3(a) shows a high-quality uniform finite element mesh, FIG. 3(b) shows a low-quality uniform finite element mesh, FIG. 3(c) shows a high-quality refined finite element mesh, and FIG. 3(d) shows a low-quality refined finite element mesh;

FIG. 4 is a view showing the arrangement and shape of a virtual grid, which indicates that the size of the virtual grid is selected to be similar to the size of a finite element;

FIG. 5 shows views depicting a two-dimensional stress recovery process according to the present invention, wherein FIG. 5(a) shows a low-quality finite element mesh, FIG. 5(b) shows the generation of a virtual grid for stress recovery, FIG. 5(c) shows the calculation of the displacement values of the virtual grid nodes using an interpolation method, and FIG. 5(d) shows the calculation of stress values at the Gauss points of the virtual grid;

FIG. 6 shows views directed to the calculation of displacement values of a virtual grid nodes, wherein FIG. 6(a) shows searching for a finite element including a virtual grid node Nₚ, and FIG. 6(b) shows the calculation of the displacement value uₚ of the virtual grid node Np using the displacement values u₁, u₂, and, u₃ of finite element nodes N₁, N₂, and N₃;

FIG. 7 is a view directed to a J-integral domain, which illustrates a J-integral domain including an arbitrary crack tip;

FIG. 8 shows views depicting a finite element mesh for the verification of a two-dimensional stress recovery technique, wherein FIG. 8(a) shows a high-quality mesh (a 4k structured mesh), and FIG. 8(b) shows a low-quality mesh (a 4k perturbed mesh);

FIG. 9 shows views depicting estimated strain fields, wherein FIG. 9(a) shows the strain field of a 4k structured mesh, FIG. 9(b) shows the strain field of a 4k perturbed mesh calculated in finite elements, and FIG. 9(c) shows the strain field of a 4k perturbed mesh calculated using a stress recovery technique;

FIG. 10 shows views depicting the relative errors of the estimated strains, wherein FIG. 10(a) shows the relative strain error of the 4k structured mesh, FIG. 10(b) shows the relative strain error of the 4k perturbed mesh calculated in the finite elements, and FIG. 10(c) shows the relative strain error of the 4k perturbed mesh calculated using the stress recovery technique;

FIG. 11 shows views depicting the formation of a free mesh for a three-dimensional stress recovery technique, wherein FIG. 11(a) shows a case of a straight crack front, and FIG. 11(b) shows a case of a curved crack front; and

FIG. 12 shows a three-dimensional J-integral domain.

### DETAILED DESCRIPTION

Embodiments of the present invention will be described with reference to the accompanying drawings so that those of ordinary skill in the art to which the present invention pertains can easily practice the present invention. As can be easily understood by those of ordinary skill in the art to which the present invention pertains, the embodiments to be described later may be modified in various forms without departing from the concept and scope of the present invention. The same or similar portions are denoted by the same reference numerals throughout the drawings as much as possible.

The technical terms used herein are intended merely to refer to specific embodiments, but are not intended to limit the invention. In this case, the singular forms used herein also include plural forms unless the phrases clearly indicate the opposite.

The term “include” or “including” is intended to specify the presence of stated features, means, steps or components, but does not exclude the presence or addition of one or more other features, means, steps, components or a group thereof.

All the terms including technical or scientific terms used herein have the same meanings as commonly understood by those of ordinary skill in the art to which the present invention pertains. The terms defined in the dictionaries are further interpreted as having meanings consistent with the related technical documents and the presently disclosed content, and are not interpreted as having ideal or excessively formal meanings unless defined as such.

The determination of crack stability and prediction of crack growth for a structure using finite element analysis are made through the analysis of stress field distribution or calculation of a stress intensity factor around a crack tip. In this case, in order to accurately calculate a stress field and the stress intensity factor around the crack tip, a fine and structured mesh is required around the crack tip, which may cause difficulties in modeling depending on the shape of a structure.

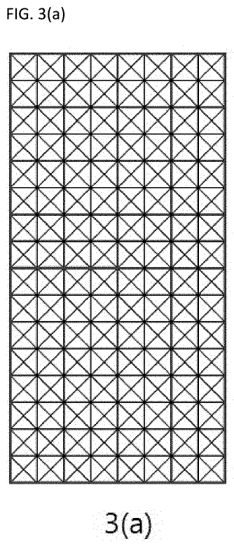

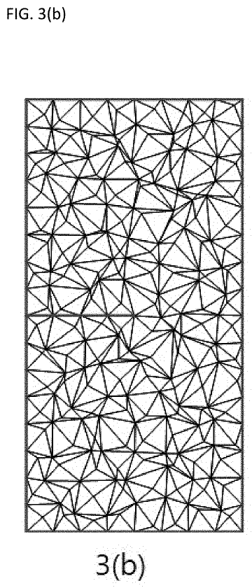

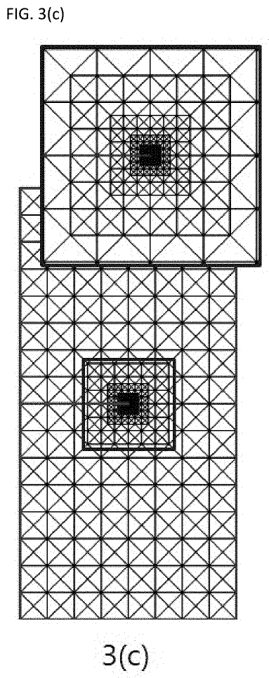

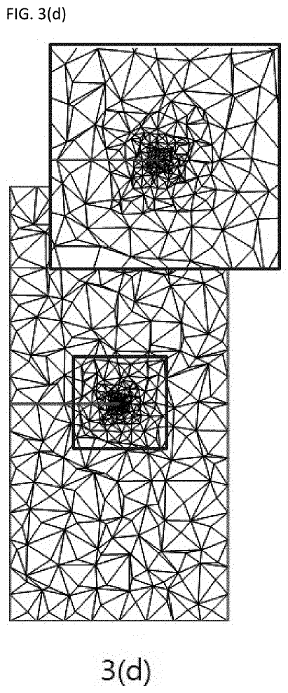

For reference, FIG. 3 shows the types of finite element meshes. FIG. 3(a) shows a high-quality uniform finite element mesh, FIG. 3(b) shows a low-quality uniform finite element mesh, FIG. 3(c) shows a high-quality refined finite element mesh, and FIG. 3(d) shows a low-quality refined finite element mesh. Therefore, in the present invention, a free mesh is utilized, which provides efficiency on meshing, and a virtual grid technique is proposed to accurately calculate a stress field and a stress intensity factor around a crack tip.

The present invention will be described below with reference to the accompanying drawings. Note that the drawings may be partially exaggerated in order to illustrate features of the present invention. These items are preferably interpreted in light of the overall context of the present specification.

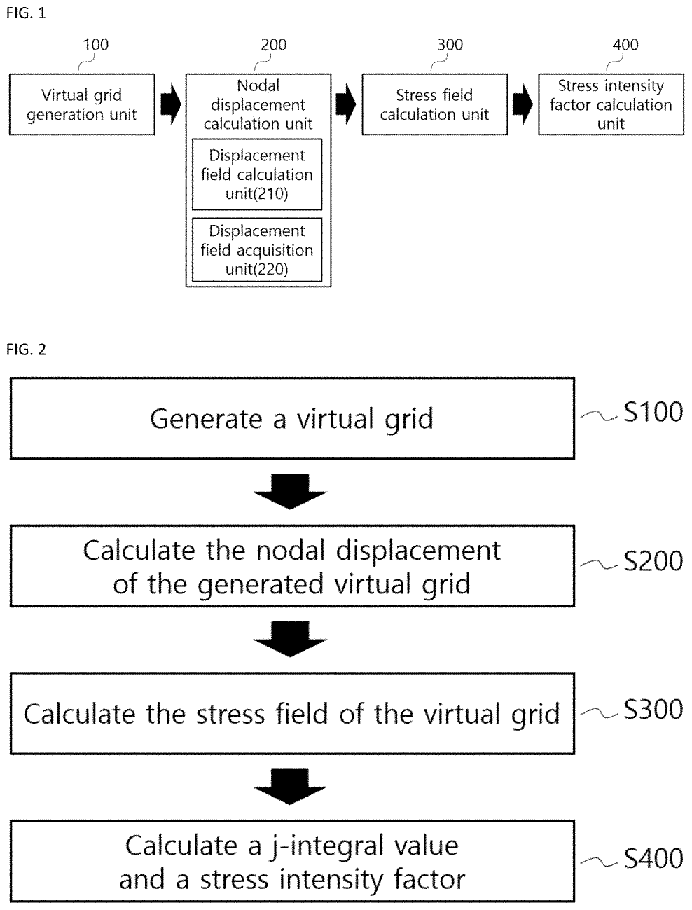

FIG. 1 is a block diagram of a stress intensity factor evaluation system using a virtual grid (a virtual mesh) according to the present invention.

The present invention is directed to a stress intensity factor evaluation system using a virtual grid in which a control server having a computational function is executed via a computer. The control server according to the present invention includes: a virtual grid generation unit 100 configured to generate a virtual grid; a nodal displacement calculation unit 200 configured to calculate the nodal displacement of the generated virtual grid; a stress field calculation unit 300 configured to calculate the stress field of the virtual grid;

and a stress intensity factor evaluation unit 400 configured to calculate a J-integral value and a stress intensity factor.

In finite element analysis, when a low-quality finite element mesh is used, the accuracy of a calculated stress field may be deteriorated, which may negatively affect the accuracy of a stress intensity factor. Accordingly, the present invention proposes a stress recovery technique using a free mesh for the accurate calculation of a stress field and a stress intensity factor in a low-quality mesh. The virtual grid generation unit 100 will be described below.

The virtual grid generation unit 100 according to the present invention generates a virtual grid by using two-dimensional four-node elements or three-dimensional eight-node elements in a target region for stress recovery. In this specification, the present invention will be described with a focus on two-dimensional four-node elements.

In the virtual grid generation unit 100 according to the present invention, the center of the virtual grid is identical to the center of a crack, and the shape and size of the virtual grid is determined according to the shape and size of finite elements.

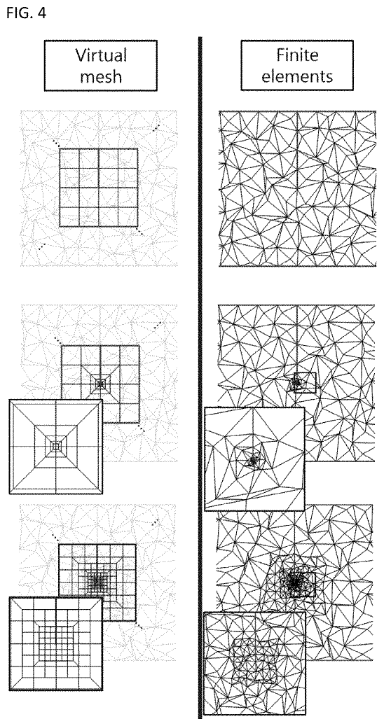

FIG. 4 shows the arrangement and shape of a virtual grid, and the size of the virtual grid is selected to be similar to the size of a finite element.

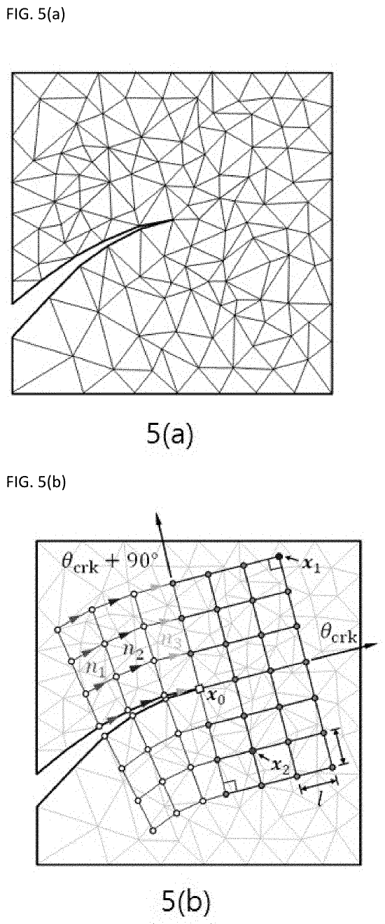

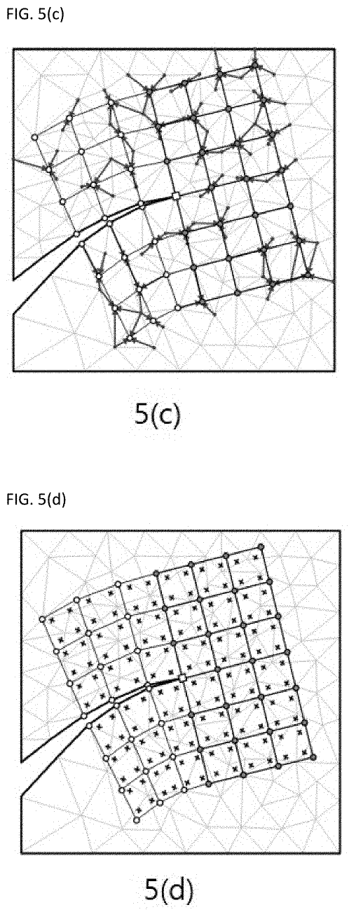

FIG. 5 shows a two-dimensional stress recovery process according to the present invention. FIG. 5(a) shows low-quality finite elements, FIG. 5(b) shows the generation of a virtual grid for stress recovery, FIG. 5(c) shows the calculation of the displacement values of the nodes of the virtual grid using an interpolation method, and FIG. 5(d) shows the calculation of stress values at the Gauss positions of the virtual grid.

A virtual mesh (a virtual grid) is generated using two-dimensional four-node elements in a target region for stress recovery, as shown in FIG. 5(b). The center of the virtual grid is identical to the location of the tip of a crack, and virtual grid nodes located in front of the crack tip are generated at the locations perpendicular and horizontal to the direction in which the crack propagates. Nodes located behind the crack tip are generated at locations perpendicular and horizontal to the plane of the crack.

For example, in FIG. 5(b), the locations of the nodes x₁=x₁, y₁ and x₂=x₂, y₂ of the virtual grid are calculated as in Equation 1 below:

x₁=x₀+3\sqrt{2} l cos(θ_{crk}+45°)

y₁=y₀+3\sqrt{2} l sin(θ_{crk}+45°)

x₂=x₀+\sqrt{5} l cos(θ_{crk}−tan⁻¹(2))

y₂=y₀+\sqrt{5} l sin(θ_{crk}−tan⁻¹(2)) (1)

The nodal displacement calculation unit 200 will be described below.

The nodal displacement calculation unit 200 according to the present invention calculates the nodal displacement of the virtual grid, and includes a displacement field calculation unit 210 and a displacement field acquisition unit 220.

The displacement field calculation unit 210 according to the present invention calculates the displacement field of the virtual grid through interpolation using shape functions used for finite element analysis and the locations of the virtual grid nodes. For example, when the virtual grid node is located inside a finite element, the nodal displacement of the virtual grid is calculated as in Equation 2 below:

uₚ=ξ₁u₁+ξ₂u₂+ξ₃u₃ (2)

where uₚ denotes the nodal displacement of the virtual grid, u₁, u₂, and u₃ denote the displacements of the finite element, and ξ₁, ξ₂, ξ₃ denote the shape functions of the finite element.

In a triangular finite element, the shape functions are defined as in Equation 3 below:

$${ξ}_{1} = \frac{1}{2 A} [ ( {x}_{2} {y}_{3} - {x}_{3} {y}_{2} ) + ( {y}_{2} - {y}_{3} ) x + ( {x}_{2} - {x}_{3} ) y ] \qquad ( 3 )$$

$${ξ}_{2} = \frac{1}{2 A} [ ( {x}_{3} {y}_{1} - {x}_{1} {y}_{3} ) + ( {y}_{3} - {y}_{1} ) x + ( {x}_{3} - {x}_{1} ) y ]$$

$${ξ}_{3} = \frac{1}{2 A} [ ( {x}_{1} {y}_{2} - {x}_{2} {y}_{1} ) + ( {y}_{1} - {y}_{2} ) x + ( {x}_{1} - {x}_{2} ) y ]$$

where x₁, x₂, and x₃ and y₁, y₂, and y₃ are the coordinates of a triangle, A is the area of the triangle, and x and y are locations inside the triangle for which shape function values are to be calculated.

The displacement field acquisition unit 220 according to the present invention calculates the nodal displacement of the virtual grid through the least squares method based on the coordinate and displacement values of a finite element and the location of the virtual grid node. An equation for the least squares method for virtual grid node calculation is defined as Equation 4 below:

rₓ=Pq^{x}−b^{x}, r_{y}=Pq^{y}−b^{y} (4)

In this equation, P is shape functions based on the coordinates of the finite element, and b is the nodal displacement value of the finite element. The nodal displacement value of the virtual grid is calculated by calculating constants qₓ and q_{y}, minimizing r, through the least squares method and then multiplying P and q.

A variable m constituting the shape function matrix P used in the present invention is represented by Equation 5 below:

$$m = [ \begin{matrix}1 & \frac{x - {x}_{w}}{{h}_{w}} & \frac{y - {y}_{w}}{{h}_{w}}\end{matrix} ] \qquad ( 5 )$$

where x and y denote locations inside the triangle for which the shape function values are to be calculated, x_{w} and y_{w} denote the coordinates of the triangular nodes, and h_{w} denotes the size of the triangle.

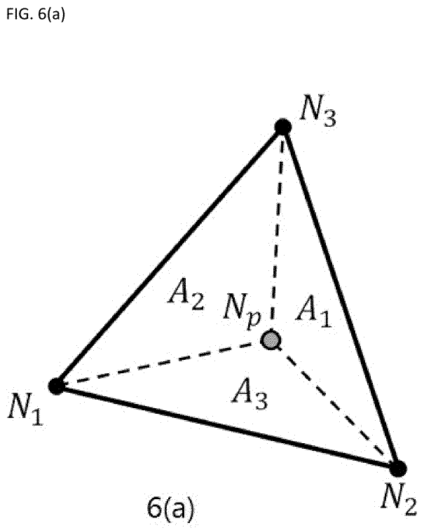

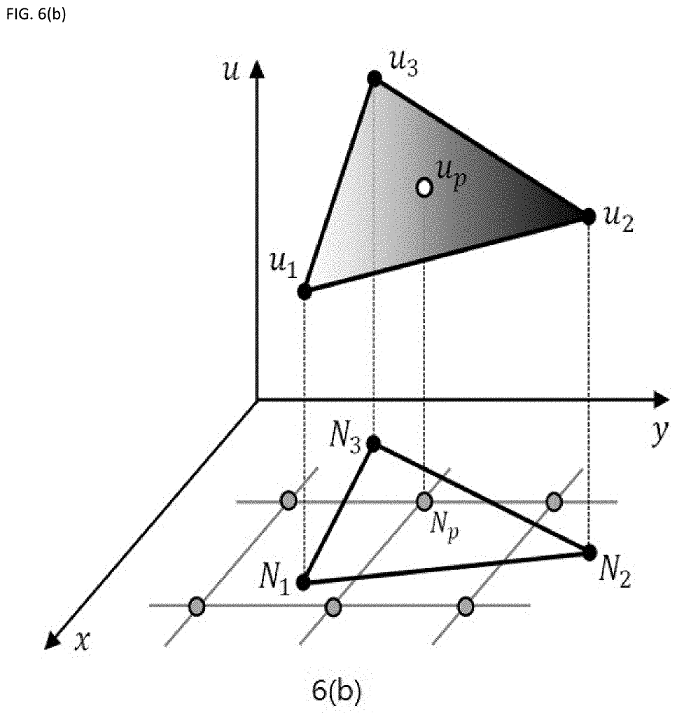

FIG. 6 is directed to the calculation of the nodal displacement value of a virtual grid. FIG. 6(a) shows the procedure to search for a finite element including a virtual grid node Nₚ, and FIG. 6(b) shows the calculation of the displacement value uₚ of the virtual grid node Nₚ using the displacement values u₁, u₂, and, u₃ of finite element nodes N₁, N₂, and N₃.

The present invention searches for a finite element including the node location of a free mesh in order to calculate the nodal displacement of the free mesh.

For example, when a free mesh node Nₚ is present inside a finite element consisting of nodes N₁, N₂, and N₃ (see FIG. 6(a)), the displacement value of the free mesh node Nₚ may be obtained using the displacement values of the nodes N₁, N₂, and N₃ and Lagrange shape functions (see FIG. 6(b)).

Thereafter, by using the nodal displacement values of the free mesh, stress values is calculated at the Gauss points of the free mesh (see FIG. 5(d)).

For a two-dimensional free mesh, in the present invention, four-node rectangular elements Q4 are used, and stress values are measured at four Gauss points for each free element.

The stress field calculation unit 300 will be described below.

The stress field calculation unit 300 according to the present invention calculates the stress field of the virtual grid.

The stress field calculation unit 300 according to the present invention calculates stress values at the Gauss points of the virtual grid by using the shape functions and the nodal displacement of the virtual grid calculated by the displacement field calculation unit 210. Equation 6 below shows a calculation formula for stress a at a Gauss point.

σ=DBd (6)

In this equation, D denotes the tangential stiffness matrix of a stress-strain relationship and is calculated using material properties such as elastic modulus and Poisson's ratio. d denotes the nodal displacement of the virtual grid element. B is a matrix composed of the derivatives of the shape functions.

In a general linear rectangular element, shape functions are defined as in Equation 7 below:

N₁=¼(1−s)(1−t) N₂=¼(1+s)(1−t)

N₃=¼(1+s)(1+t) N₄=¼(1−s)(1+t) (7)

where N denotes the shape functions of the rectangular element, and s and t denote the local coordinates of the rectangular element.

Furthermore, the stress field calculation unit 300 according to the present invention calculates the stress field through first derivation for the displacement field on the virtual grid acquired by the displacement field acquisition unit 220.

The stress intensity factor evaluation unit 400 will be described below.

The stress intensity factor evaluation unit 400 according to the present invention calculates the stress intensity factor value using results calculated by the nodal displacement calculation unit 200 and the stress field calculation unit 300 and a domain integral method.

In the present invention, the target of the domain integral method is a generated virtual grid and is integrated according to Equation 8 below:

$$J = {\int }_{A} ( {σ}_{ij} \frac{\partial {u}_{j}}{\partial {x}_{k}} - W {δ}_{k i} ) \frac{\partial {q}_{k}}{\partial {x}_{i}} d A - {\int }_{{C}^{+} + {C}^{-}} {t}_{i} \frac{\partial {u}_{i}}{\partial {x}_{k}} {q}_{k} d C \qquad ( 8 )$$

where σᵢⱼ is stress, tᵢ is traction acting on a crack surface, uᵢ is a displacement, W is strain energy, δₖᵢ is the Kronecker delta, and qₖ is an arbitrary continuous function, which has a value of 1 at the crack tip and a value of 0 at the boundary of an integral domain.

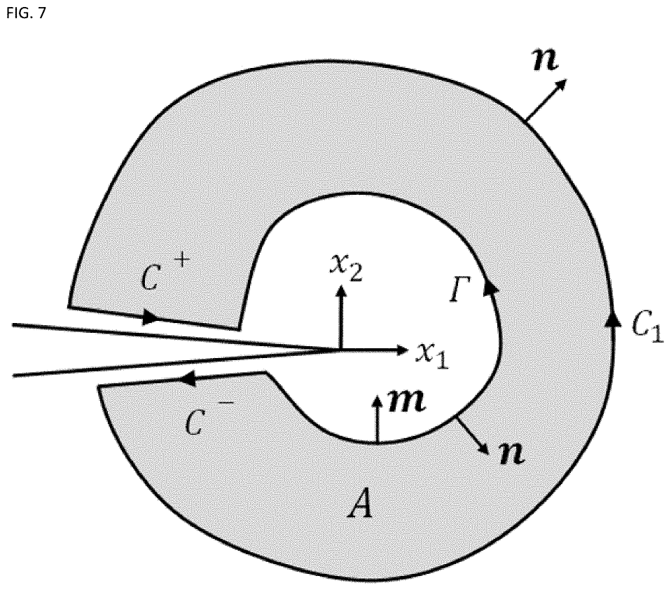

FIG. 7 is directed to a J-integral domain, and illustrates a J-integral domain including an arbitrary crack tip. A denotes the J-integral domain, C⁺ denotes the top crack surface, C⁻ denotes the bottom crack surface, C₁ denotes the outside line of the J-integral domain, I denotes the inside line of the J-integral domain, n denotes the vertical vector of the J-integral line, and m denotes an outer vector.

A two-dimensional free mesh-based stress recovery technique according to the present invention will be described below.

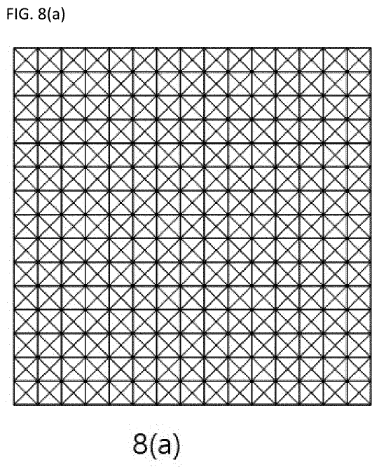

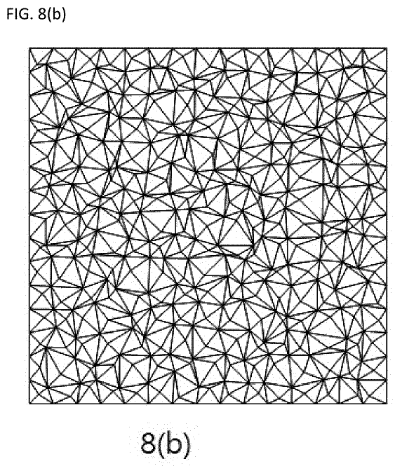

FIG. 8 shows a finite element mesh for the verification of a two-dimensional stress recovery technique. FIG. 8(a) shows a high-quality mesh (a 4k structured mesh), and FIG. 8(b) shows a low-quality mesh (a 4k perturbed mesh). After an arbitrary displacement field has been set in a 0.1×0.1 rectangular area, a strain error is measured. Two types of finite elements (high-quality elements, and low-quality elements) are used for numerical analysis, and three-node linear elements (constant-strain triangles (CSTs)) may be used (see FIG. 8).

In the case of the high-quality elements (the 4k structured mesh), the strain field is calculated directly in a finite element.

In the case of the low-quality elements (the 4k perturbed mesh), the strain field is estimated using two approaches. As a first method, the strain field is measured directly in a low-quality finite element. As a second method, the strain field is estimated using a proposed stress recovery technique.

For an arbitrary displacement field, a horizontal displacement field uₓ(x,y)=10⁻³(x²+x) is set at the nodes of finite elements, and a vertical displacement field is fixed as u_{y}(x,y)=0 (see FIG. 6).

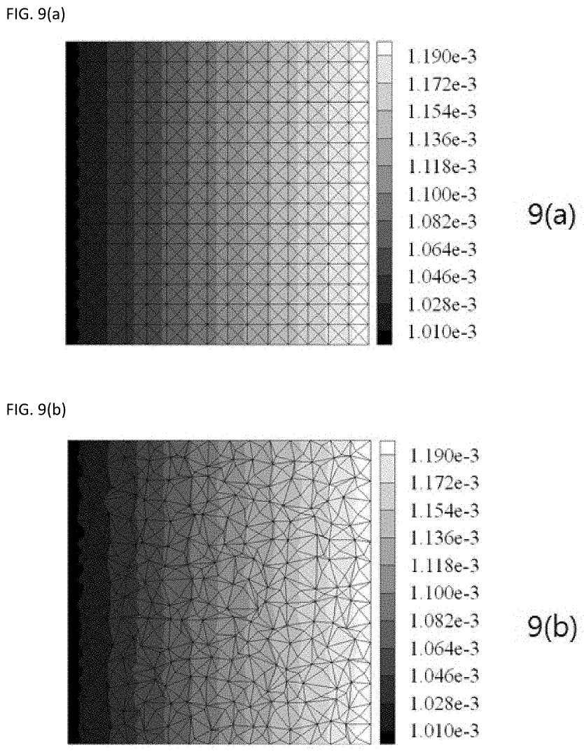

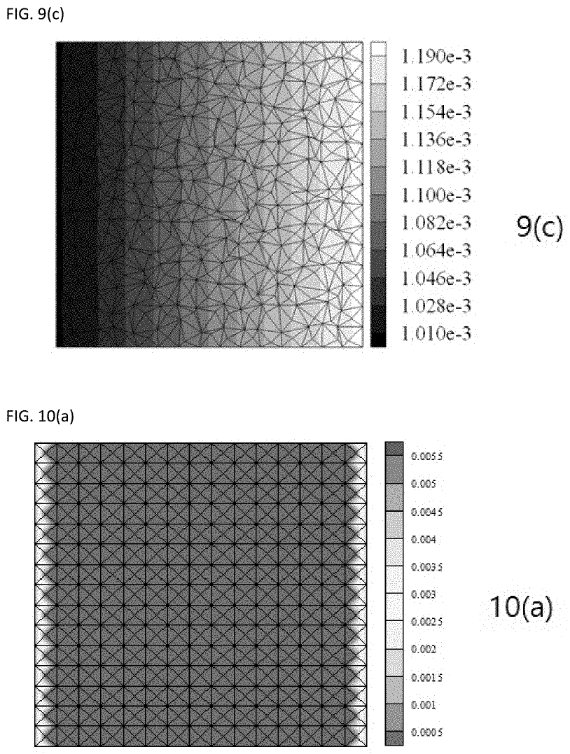

FIG. 9 shows measured strain fields. FIG. 9(a) shows the strain field of a 4k structured mesh, FIG. 9(b) shows the strain field of a 4k perturbed mesh calculated in finite elements, and FIG. 9(c) shows the strain field of a 4k perturbed mesh calculated using a stress recovery technique.

The strain fields calculated in the 4k structured mesh and the 4k perturbed mesh are illustrated together with the meshes in FIG. 9.

It can be seen that the strain field is uniformly distributed in the 4k structured mesh, i.e., a high-quality mesh (see FIG. 9(a)).

In contrast, when the strains of the 4k perturbed mesh, i.e., a low-quality mesh, are directly calculated in the finite elements, it can be seen that a strain field appears non-uniform, as shown in FIG. 9(b). From this, it can be inferred that low-quality elements negatively affect accuracy of the strain and stress field calculation.

Furthermore, when the strain field is calculated using the stress recovery technique for the 4k perturbed mesh, it can be seen that a strain field appears substantially uniform (see FIG. 9(c)).

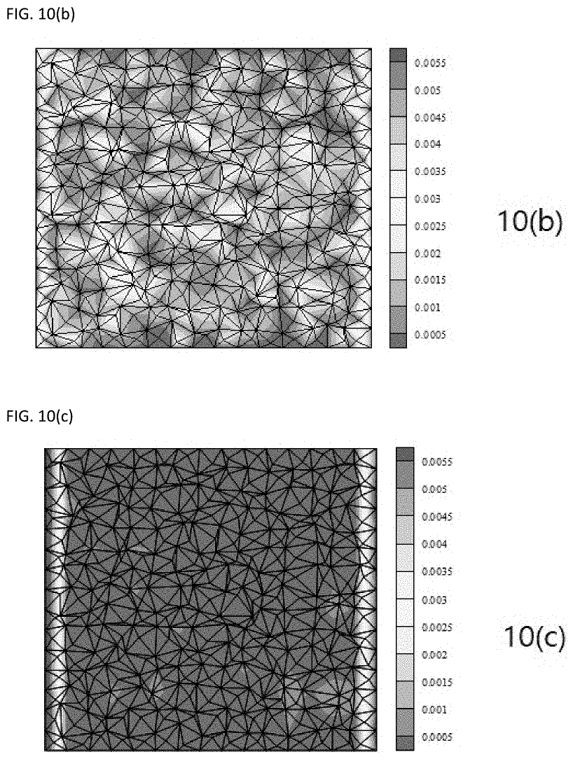

FIG. 10 shows the relative errors of the measured strains. FIG. 10(a) shows the relative strain error of the 4k structured mesh, FIG. 10(b) shows the relative strain error of the 4k perturbed mesh calculated in the finite elements, and FIG. 10(c) shows the relative strain error of the 4k perturbed mesh calculated using the stress recovery technique.

Additionally, the relative error of stain field is calculated by comparing the strain field obtained from each mesh with an analytical solution of the strain field. In the case of the 4k structured mesh, the relative error of most of the internal nodes have a value of 0.001 or less (see FIG. 10(a)).

In contrast, in the case of the 4k perturbed mesh, it can be seen that the relative errors are significantly increased (see FIG. 10(b)).

Finally, when the stress recovery technique is applied to the 4k perturbed mesh, it can be seen that the distribution of relative error shows values similar to the results obtained from the 4k structured mesh (see FIG. 10(c)).

In conclusion, it is confirmed that in the case where the proposed stress recovery technique is utilized to evaluate the stress field for the low-quality mesh, more accurate results can be obtained than the measurement of a stress field in general finite elements.

A three-dimensional stress recovery technique based on a free mesh according to the present invention will be described below.

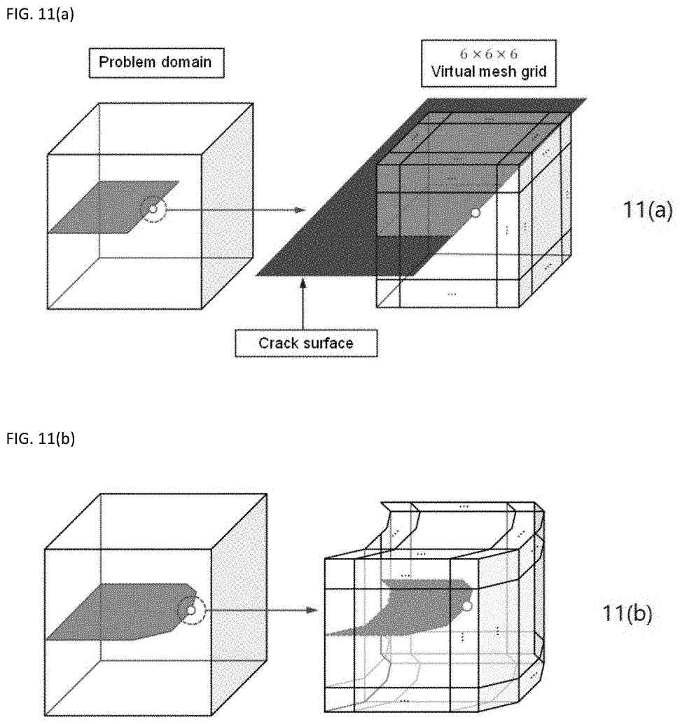

FIG. 11 shows the formation of a free mesh for a three-dimensional stress recovery technique. FIG. 11(a) shows a case of a straight crack front, and FIG. 11(b) shows a case of a curved crack front.

The stress recovery method according to the present invention may be extended to three dimensions for use in three-dimensional finite element analysis.

The basic details of the stress recovery method are the same as the two-dimensional one, and eight-node hexahedral elements are used to form a virtual grid (see FIG. 11).

When the nodal displacement value of the virtual grid is calculated, the shape functions of four-node tetrahedral elements used in three-dimensional finite element analysis are used.

Two-dimensional virtual grid-based J-integral calculation will be described below.

Using the two-dimensional stress recovery method according to the present invention, a stress intensity factor is calculated at a crack tip. J-integration is used to calculate the stress intensity factor, and a virtual grid is adopted for a J-integral target domain.

The suitable shape of a virtual grid can be set for J-integration, regardless of the shape of an actual finite element mesh. An area integral is used for J-integration (see FIG. 7), and a two-dimensional area integral equation may be represented by Equation 2 above.

In Equation 2, σᵢ is stress, tᵢ is traction acting on a crack surface, uᵢ is a displacement, W is strain energy, δₖᵢ is the Kronecker delta, and qₖ is an arbitrary continuous function, which has a value of 1 at a crack tip and a value of 0 at the boundary of the integral domain.

In the present invention, qₖ is defined using a plateau function.

By discretizing Equation 8 for finite element analysis, it can be rewritten by Equation 9 below:

$$J = {\sum }_{elements} {{\sum }^{4}}_{p = 1} {\{ [ ( {σ}_{ij} \frac{\partial {u}_{j}}{\partial {x}_{k}} - W {δ}_{ki} ) \frac{\partial {q}_{k}}{\partial {x}_{i}} ] det ( \frac{\partial {x}_{k}}{\partial {η}_{k}} ) \}}_{p} {w}_{p} - {\sum }_{edges} \{ {t}_{i} \frac{\partial {u}_{j}}{\partial {x}_{k}} {q}_{k} \} w \qquad ( 9 )$$

For all elements constituting a virtual grid, a J-integral value is calculated via Equation 9, and then a stress intensity factor value is acquired according to the plane stress or strain conditions of finite element analysis defined by Equation 10 below:

K_{I}=½\sqrt{E*}(\sqrt{J₁−J₂}+\sqrt{J₁+J₂})

K_{II}=½\sqrt{E*}(\sqrt{J₁−J₂}−\sqrt{J₁+J₂}) (10)

In this equation, K_{I} and K_{II} denote first- and second-mode stress intensity factors, respectively, and J₁ and J₂ denote first- and second-mode J-integral values, respectively. E* is defined as Equation 11 below according to a plane strain or plane stress state.

E*=E (plane stress)

E*=E/(1−v²) (plane strain) (11)

where E and v are elastic modulus and Poisson's ratio, respectively.

The three-dimensional virtual grid-based J-integral calculation will be described below.

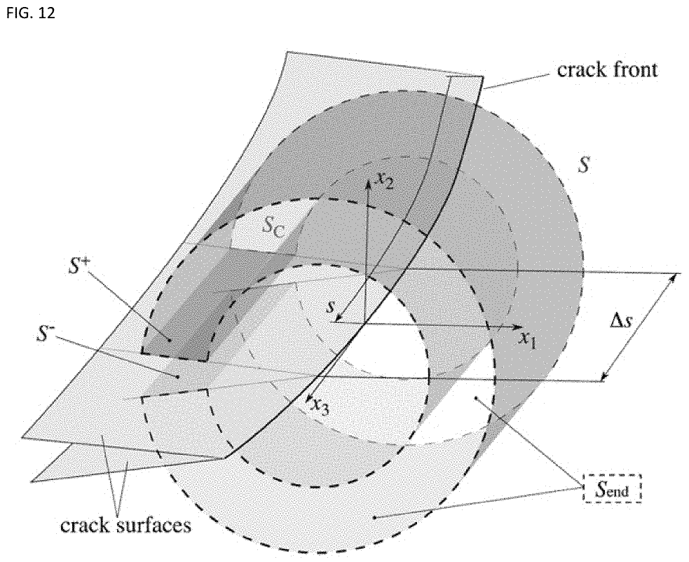

FIG. 12 shows a three-dimensional J-integral domain.

Using the three-dimensional stress recovery technique according to the present invention, a stress intensity factor is calculated along a crack front.

A J-integral is used to calculate the stress intensity factor. The J-integral in a micro-area constituting an arbitrary crack tip is defined as Equation 12 below (see FIG. 12):

J=∫_{V}[σᵢⱼu_{j,k}−Wδₖᵢ]q_{k,i}dV−∫_{S}_{⁺}_{+S}_{^{−}}tᵢu_{i,k}qₖdS (12)

where σᵢⱼ is stress, tᵢ is traction acting on a crack surface, uᵢ is a displacement, W is strain energy, δₖᵢ is the Kronecker delta, and qₖ is an arbitrary continuous function, which has a value of 1 at a crack tip and a value of 0 at the boundary of the integral domain.

By discretizing Equation 12 for finite element analysis, it can be rewritten by Equation 13 below:

$$J = {\sum }_{elements} {\sum }_{p = 1}^{8} {\{ [ ( {σ}_{ij} \frac{\partial {u}_{j}}{\partial {x}_{k}} - W {δ}_{k i} ) \frac{\partial {q}_{k}}{\partial {x}_{i}} ] det ( \frac{\partial {x}_{k}}{\partial {η}_{k}} ) \}}_{p} {w}_{p} - {\sum }_{faces} \{ {t}_{i} \frac{\partial {u}_{j}}{\partial {x}_{k}} {q}_{k} \} W \qquad ( 13 )$$

where σᵢⱼ is stress, tᵢ is traction acting on a crack surface, uᵢ is a displacement, W is strain energy, δₖᵢ is the Kronecker delta, and qₖ is an arbitrary continuous function, which has a value of 1 at a crack tip and a value of 0 at the boundary of the integral domain.

In the three-dimensional J-integral calculation, eight-node hexahedral elements (C3D8s) are used as virtual elements, and thus Equation 6 is calculated and integrated at a total of eight Gauss points for each of the virtual element.

Meanwhile, the present invention can be implemented as a stress intensity factor evaluation method using a virtual grid.

This method is the same as the above-described stress intensity factor evaluation system in terms of the substantial content of the invention, and is different only in terms of the category of the invention. Accordingly, the above-descried details of the stress intensity factor evaluation system may also be applied to the stress intensity factor evaluation method.

The present invention provides a stress intensity factor evaluation method that is performed by a control server having a computational function via a computer, the method including: step S100 of generating, by the virtual grid generation unit 100 of the control server, a virtual grid; step S200 of calculating, by the nodal displacement calculation unit 200, the nodal displacement of the generated virtual grid; step S300 of calculating, by the stress field calculation unit 300, the stress field of the virtual grid; and step S400 of calculating, by the stress intensity factor evaluation unit 400, a J-integral value and a stress intensity factor.

The stress intensity factor evaluation system and method using a virtual grid according to the present invention have the following effects:

First, the present invention provides an accurate stress field for a low-quality mesh, and therefore a user can measure an accurate stress intensity factor and the direction in which a crack propagates.

Second, the present invention is a simple method for implementation, and provides the effect in which it can be added as a post-processing technique of commercial software. Third, when a user has a presented method as a module in a commercial program, the user can reduce the time for generating the high-quality mesh while achieving the accurate stress intensity factor. Accordingly, the present invention provides the effect of being easily implemented through the adding of a new function to a program.

The effects of the present invention are not limited to those described above, and other effects not described above will be clearly understood by those of ordinary skill in the art from the foregoing description.

In addition, the present invention may be implemented as a computer program. The present invention may be implemented as a computer program stored in a computer-readable storage medium in order to execute the stress intensity factor evaluation method using a virtual grid according to the present invention via a computer in combination with hardware.

Each of the methods according to the embodiments of the present invention described above may be implemented in the form of a program readable by various computer means and then recorded in a computer readable storage medium. In this case, the computer-readable storage medium may include program instructions, data files, and data structures solely or in combination. Program instructions recorded on the storage medium may have been specially designed and configured for the present invention, or may be known to or available to those who have ordinary knowledge in the field of computer software. Examples of the computer-readable storage medium include all types of hardware devices specially configured to record and execute program instructions, such as magnetic media, such as a hard disk, a floppy disk, and magnetic tape, optical media, such as compact disk (CD)-read only memory (ROM) and a digital versatile disk (DVD), magneto-optical media, such as a floptical disk, ROM, random access memory (RAM), and flash memory.

Examples of the program instructions include machine code, such as code created by a compiler, and high-level language code executable by a computer using an interpreter. These hardware devices may be configured to operate as one or more software modules in order to perform the operation of the present invention, and the vice versa.

The embodiments described in the present specification and the accompanying drawings are merely illustrative of some of the technical spirit included in the present invention. Therefore, it is obvious that the embodiments disclosed in the present specification are not intended to limit the technical spirit of the present disclosure but is intended to describe the technical spirit, so that the scope of the technical spirit of the present invention is not limited by these embodiments. Modifications and specific embodiments that can be easily inferred by those skilled in the art without departing from the scope of the technical spirit included in the specification and drawings of the present invention should be interpreted as being included in the scope of the present invention.

What is claimed is:

1. A stress intensity factor evaluation system using a virtual grid in which a control server having a computational function is executed via a computer, the control server comprising:
a virtual grid generation unit configured to generate a virtual grid;
a nodal displacement calculation unit configured to calculate a nodal displacement of the generated virtual grid;
a stress field calculation unit configured to calculate a stress field of the virtual grid; and
a stress intensity factor evaluation unit configured to calculate a J-integral value and a stress intensity factor.

2. The stress intensity factor evaluation system of claim 1, wherein the virtual grid generation unit is further configured to generate the virtual grid using two-dimensional four-node elements or three-dimensional eight-node elements in a target region for stress recovery.

3. The stress intensity factor evaluation system of claim 2, wherein:
a center of the virtual grid is identical to a location of a crack tip; and
a shape and size of the virtual grid are determined according to a shape and size of finite elements.

4. The stress intensity factor evaluation system of claim 1, wherein the nodal displacement calculation unit comprises a displacement field calculation unit configured to calculate a displacement field of the virtual grid through interpolation using shape functions used for finite element analysis and a nodal location of the virtual grid.

5. The stress intensity factor evaluation system of claim 4, wherein when the location the virtual grid node is located inside a finite element, the nodal displacement of the virtual grid is calculated by Equation 2 below:
uₚ=ξ₁u₁+ξ₂u₂+ξ₃u₃ (2)
where uₚ denotes the nodal displacement of the virtual grid, u₁, u₂, and u₃ denote nodal displacements of the finite element nodes, and ξ₁, ξ₂, and ξ₃ denote shape functions of the finite element.

6. The stress intensity factor evaluation system of claim 5, wherein in a triangular finite element, the shape functions are defined by Equation 3 below:
$${ξ}_{1} = \frac{1}{2 A} [ ( {x}_{2} {y}_{3} - {x}_{3} {y}_{2} ) + ( {y}_{2} - {y}_{3} ) x + ( {x}_{2} - {x}_{3} ) y ] \qquad ( 3 )$$
$${ξ}_{2} = \frac{1}{2 A} [ ( {x}_{3} {y}_{1} - {x}_{1} {y}_{3} ) + ( {y}_{3} - {y}_{1} ) x + ( {x}_{3} - {x}_{1} ) y ]$$
$${ξ}_{3} = \frac{1}{2 A} [ ( {x}_{1} {y}_{2} - {x}_{2} {y}_{1} ) + ( {y}_{1} - {y}_{2} ) x + ( {x}_{1} - {x}_{2} ) y ]$$
where x₁, x₂, and x₃ and y₁, y₂, and y₃ are coordinates of a triangular element, A is an area of the triangular element, and x and y are locations inside the triangle for which shape function values are to be calculated.

7. The stress intensity factor evaluation system of claim 4, wherein the nodal displacement calculation unit further comprises a displacement field acquisition unit configured to calculate the nodal displacement of the virtual grid through a least squares method based on coordinate and displacement values of a standard finite element and the location of the virtual grid node.

8. The stress intensity factor evaluation system of claim 7, wherein an equation for the least squares method for displacement calculation of the virtual grid node is defined as Equation 4 below:
rₓ=Pq^{x}−b^{x}, r_{y}=Pq^{y}−b^{y} (4)
where P is shape functions based on the coordinates of the finite element, b is a nodal displacement value of the finite element, and the nodal displacement value of the virtual grid is calculated by calculating constants q^{x} and q^{y}, minimizing r, through the least squares method and then multiplying P and q.

9. The stress intensity factor evaluation system of claim 8, wherein a variable m constituting the shape function matrix P is calculated by Equation 5 below:
$$m = [ \begin{matrix}1 & \frac{x - {x}_{w}}{{h}_{w}} & \frac{y - {y}_{w}}{{h}_{w}}\end{matrix} ] \qquad ( 5 )$$
where x and y denote locations inside the triangle for which shape function values are to be calculated, x_{w} and y_{w} denote coordinates of triangle nodes, and h_{w} denotes a size of the triangle.

10. The stress intensity factor evaluation system of claim 4, wherein the stress field calculation unit calculates stress values at Gauss points of the virtual grid by using the shape functions and the nodal displacement of the virtual grid.

11. The stress intensity factor evaluation system of claim 7, wherein the stress field calculation unit is further configured to calculate the stress field by taking a first derivative of the displacement field on the virtual grid acquired by the displacement field acquisition unit.

12. The stress intensity factor evaluation system of claim 1, wherein the stress intensity factor evaluation unit is further configured to calculate a value of the stress intensity factor using results, calculated by the nodal displacement calculation unit and the stress field calculation unit, and a domain integral method.

13. The stress intensity factor evaluation system of claim 12, wherein a domain for the domain integral is the generated virtual grid and is integrated according to Equation 8 below:
$$J = {\int }_{A} ( {σ}_{ij} \frac{\partial {u}_{j}}{\partial {x}_{k}} - W {δ}_{k i} ) \frac{\partial {q}_{k}}{\partial {x}_{i}} d A - {\int }_{{C}^{+} + {C}^{-}} {t}_{i} \frac{\partial {u}_{i}}{\partial {x}_{k}} {q}_{k} d C \qquad ( 8 )$$
where σᵢⱼ is stress, tᵢ is traction acting on a crack surface, uᵢ is a displacement, W is strain energy, 67 ₖᵢ is a Kronecker delta, and qₖ is an arbitrary continuous function, which has a value of 1 at a crack tip and a value of 0 at a boundary of an integral domain.

14. The stress intensity factor evaluation system of claim 13, wherein the value of the stress intensity factor is obtained according to plane stress or strain conditions of a finite element analysis defined by Equation 10 below:
K_{I}=½\sqrt{E*}(\sqrt{J₁−J₂}+\sqrt{J₁+J₂})
K_{II}=½\sqrt{E*}(\sqrt{J₁−J₂}−\sqrt{J₁+J₂}) (10)
where K_{I} and K_{II} denote first- and second-mode stress intensity factors, respectively, and J₁ and J₂ denote first- and second-mode mode J-integral values, respectively.

15. The stress intensity factor evaluation system of claim 14, wherein E* is calculated by Equation 11 below:
E*=E (plane stress)
E*=E/(1−v²) (plane strain) (11)
where E and v are elastic modulus and Poisson's ratio, respectively.

16. A stress intensity factor evaluation method using a virtual grid that is performed by a control server having a computational function via a computer, the stress intensity factor evaluation method comprising:
generating, by a virtual grid generation unit of the control server, a virtual grid;
calculating, by a nodal displacement calculation unit, a nodal displacement of the generated virtual grid;
calculating, by a stress field calculation unit, a stress field of the virtual grid; and
calculating, by a stress intensity factor evaluation unit, a J-integral value and a stress intensity factor.

17. A computer program stored in a computer-readable storage medium in order to execute the stress intensity factor evaluation method of claim 16 via a computer in combination with hardware.
